(19) United States
(12) Patent Application Publication
(10) Pub. No.: US 2004/0264413 A1
(43) Pub. Date: Dec. 30, 2004

(54) Device, system and method for channel scanning

(76) Inventors: Oren Kaidar, Givat Ada (IL); Boris Ginzburg, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/603,859

(22) Filed: Jun. 26, 2003

(51) Int. Cl. H04Q 7/00; H04Q 7/24

(52) U.S. Cl. 370/332; 370/338; 370/328; 455/509

(57) ABSTRACT

A device, system and method for scanning channels on a wireless network. A device receives packets or other information for a channel and determines, from the received packets information regarding the channel. If the information indicates the channel is not desirable, before an informational packet (e.g., a beacon frame) is received, the device switches to a different channel for scanning.

### BACKGROUND OF THE INVENTION

In a wireless local area network (WLAN) a station searching for a basic service set (e.g., an Access Point) may scan a set of channels. The station may scan channels, for example, actively (which may, for example, be based on a probe request) or passively (for example, only listening to the channel). Passive scanning may be slower than active scanning. One reason may be that in passive scanning a station may wait for information such as, for example, a beacon frame or packet or a probe response before joining the network or making a request to join the network. After receiving a beacon or other informational frame the station extracts the information from the beacon and decides if it wants to use the channel. Waiting for a beacon or other informational frame before making a decision as to whether or not to join a channel which is most suitable, delays the process of joining a network. However, passive scanning may be required when, for example, active scanning is not allowed (e.g., because of regulatory limitations).

### BRIEF DESCRIPTION OF THE DRAWINGS

The present invention will be understood and appreciated more fully from the following detailed description taken in conjunction with the drawings in which:

FIG. 1 depicts a network and various components according to one exemplary embodiment of the present invention; and

FIG. 2 is a flowchart depicting a series of operations according to an exemplary embodiment of the present invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as, for example electronic, quantities within the computing system's registers and/or memories into other data similarly represented as physical quantities within the computing system's memories, registers or other such information storage, transmission or display devices.

Exemplary embodiments of the present invention are not described with reference to any particular programming language, machine code, etc. It will be appreciated that a variety of programming languages, machine codes, etc. may be used to implement the teachings of the invention as described herein.

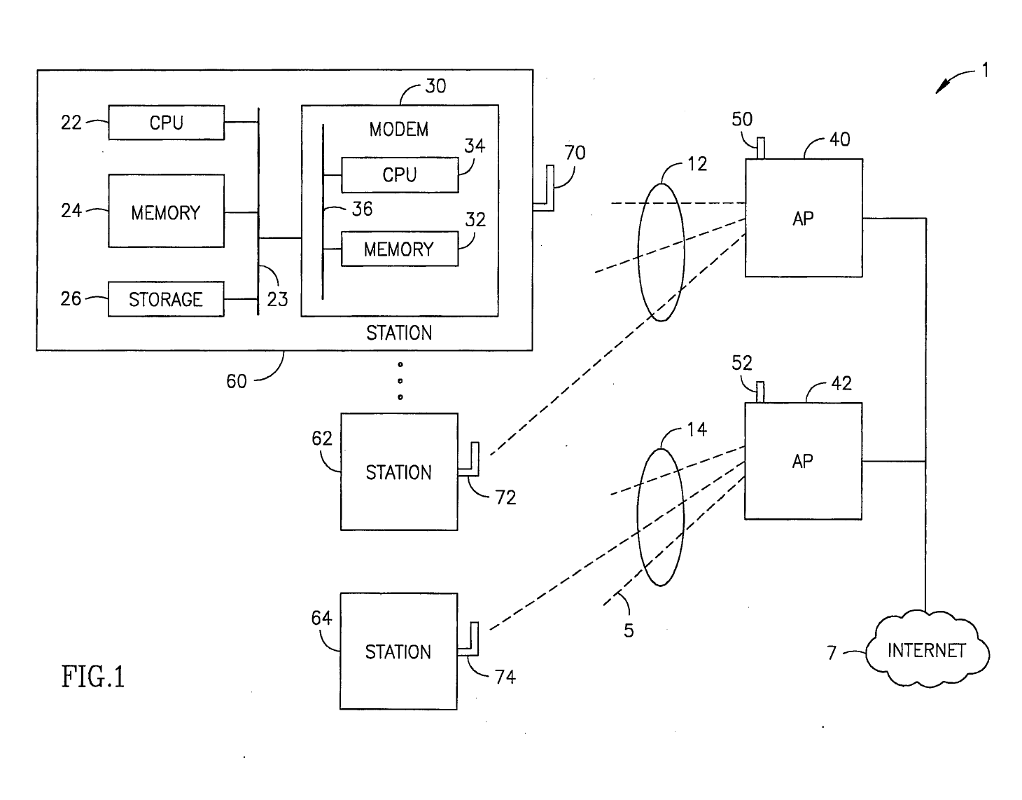

FIG. 1 depicts a network and various components according to one embodiment of the present invention. Referring to FIG. 1, network 1 may include one or more access points (APs) 40 and 42, which connect stations (sometimes denoted “STA”) 60, 62 and 64 to a network 7, which in FIG. 1 is the Internet, but which may be any network, such as, for example, a local area network (LAN), wide area network (WAN), etc. Only two APs 40 and 42 are shown, and only three stations 60, 62 and 64 are shown, but other numbers of APs and stations may be used. APs 40 and 42 may also connect stations 60, 62 and 64 to other equipment such as, for example, personal computers, workstations, printers, etc. Network traffic 5 among stations 60, 62 and 64 and APs 40 and 42 may include radio waves carrying digital data, but in other embodiments may be in different forms.

APs 40 and 42 may be standard wireless bidirectional communications links allowing for other wireless devices (e.g., stations 60, 62 and 64) to connect to a network such as, for example network 7. Communications links having structures and functionalities other than such access points or other than equipment commonly termed “access points” may be used. APs 40 and 42 may include antennas 50 and 52 such as, for example, dipole antennas, omni directional antennas, or other suitable antennas.

Stations 60, 62 and 64 may be or include wireless communications devices. For example, station 60 may be a personal computer which may be portable (e.g., a “laptop”) including a wireless modem 30. Such a wireless modem 30 may be, for example, a mini-Peripheral Component Interconnect (PCI) wireless network adaptor or may be another type of wireless communications device. Stations may be other computing devices, such as, for example personal digital assistants, cellular telephones, etc. Stations 60, 62 and 64 or modem 30 may include antennas (e.g., antennas 70, 72 and 74) such as, for example, dipole antennas, omni directional antennas, or other suitable antennas.

Station 60 may include, for example, a controller or processor 22 (e.g., one or more central processing units (CPUs) or microprocessors), a memory or storage unit 24 (e.g., one or more random access memories (RAMs) or read only memories (ROMs)), a mass storage unit 26 (e.g., a hard disk, floppy disk, flash memory, etc.), one or more busses 23, and a wireless modem 30. The method as discussed herein may be performed, for example, by a processor or controller executing software or instructions which are stored, for example, in memory or on a floppy disk, hard disk, flash card, or other suitable storage medium; for example on mass storage unit 26 or in storage unit 24. Other methods of performing the method may be used. Mass storage unit 26 or storage unit 24 may be or may be included in, for example, an article (e.g., disk jacket, case, holder, etc.) including a storage medium holding the instructions.

Wireless modem 30 may include standard computational components, such as, for example, a control unit or processor 34, such as, for example a microprocessor, CPU, etc, a memory unit 32, and one or more busses 36.

In operation, depending on the configuration, either or both of processor 22 or processor 34 may act as a controller to carry out a method according to an exemplary embodiment of the present invention. While for the sake of clarity such components are shown included in only one station 60, other stations 62 and 64 may include similar components. Various stations among stations 60, 62 and 64 may include different sets of components and different functionalities, and may carry out the methods discussed herein in different manners. In other embodiments, having equipment with different configurations, different components may act as a controller.

APs 40 and 42 may communicate with stations 60, 62 and 64, network 7 or other networks, and possibly with each other. In one example of operation, APs 40 and 42 communicate with stations 60, 62 and 64 using, for example, packets or other discrete units of information, to provide stations 60, 62 and 64 access to network 7. APs 40 and 42 may operate on one frequency or channel of channels 12 and 14 at a time (represented in FIG. 1 by a set of traffic) and provides a Basic Service Set (BSS) according to the IEEE 802.11 standard to clients such as, for example stations 60, 62 and 64 on that channel of channels 12 and 14. Note while only two channels 12 and 14 are shown, other numbers of channels may be used. However, other standards and systems may be used, and further an access point to a network may use more than one channel. Two APs 40 and 42 using a channel of channels 12 and 14 may be separated so that the two APs 40 and 42 operate in substantially different areas. In a given local area, one AP of APs 40 and 42 may operate, although multiple APs of APs 40 and 42 may operate in substantially the same area if traffic warrants. Overlap may occur between different APs 40 and 42 using the same channel of channels 12 and 14. Other systems of organization are within the scope of the present invention.

APs 40 and 42 may periodically transmit an informational frame or packet such as, for example a beacon frame which may provide information on the service the particular AP of APs 40 and 42 provides to, for example, stations 60, 62 and 64. A beacon frame or packet may include information on, for example, BSS capability or other information which allows stations 60, 62 and 64 to make a decision if they want to or can join the corresponding BSS. Stations may, in response, send request to APs to connect to the APs. Alternately, stations 60, 62 and 64 may send a request such as, for example a probe request to an AP of APs 40 and 42, requesting information on the AP, and the AP may respond with a probe response or other informational packet. For example, a beacon frame may include the name or address of an AP of APs 40 and 42, and also may include other information such as, for example synchronization signals or commands. A beacon frame may be sent periodically, such as, for example every 100 or 200 milliseconds. Other intervals may be used, and other methods for establishing a connection may be used.

If a station of stations 60, 62 and 64 decides to join a BSS it may send a request to an AP of APs 40 and 42 to connect to the AP. In one embodiment, using the IEEE 802.11 standard, such a request is termed an association request. An AP of APs 40 and 42 may send a message, such as an association response, to a station of stations 60, 62 and 64 allowing the station to use the services of the AP.

A station of stations 60, 62 and 64 may decide to attempt to connect to an AP of APs 40 and 42 because, for example, a connection to the network 7 is desired or the station moves from the service area of one AP of APs 40 and 42 to that of another. In such cases or other cases (e.g., an AP of APs 40 and 42 malfunctions), a station of stations 60, 62 and 64 may search for an appropriate AP of APs 40 and 42 to join. Such a search may involve scanning a number of channels 12 and 14, for example passively (although active techniques may be used) to find an AP of APs 40 and 42 that is desirable. Various measures of desirability may be, for example, distance or signal strength (e.g., measured by Radio Signal Strength Indicator or “RSSI”, or other measures), low traffic, high quality service, a certain level of data transfer rates, security level, or other characteristics.

When searching for a channel of channels 12 and 14 or AP of APs 40 and 42, a station of stations 60, 62 and 64 may gather information on one channel of channels 12 and 14 associated with an AP of APs 40 and 42 and, if appropriate, may switch to receiving information on another channel of channels 12 and 14 associated with another AP of APs 40 and 42 before a beacon frame, probe response, or other informational frame is received. The station of stations 60, 62 and 64 may not wait for a beacon frame or other informational frame to be received before deciding whether or not to join with the AP of APs 40 and 42. A station of stations 60, 62 and 64 may make a negative decision regarding the channel of channels 12 and 14 or AP of APs 40 and 42, and decide to use another AP or channel if, for example, the load is too high. Other factors may cause a station of stations 60, 62 and 64 to decide not to use a channel of channels 12 and 14 or AP of APs 40 and 42 and to move to a different channel or AP, such as, for example quality, AP characteristics, etc. On the receipt of an informational packet such as, for example a beacon or a probe response, a station of stations 60, 62 and 64 may attempt to join the AP of APs 40 and 42 by, for example, sending a request to join or associate (which may include, for example, an authentication frame, an association request frame, or other information) to the AP.

In an exemplary embodiment, a station of stations 60, 62 and 64 sequentially scans a set of available channels of channels 12 and 14. The range of channels of channels 12 and 14 may be scanned once, but may be scanned more than once. A timeout may allow a station of stations 60, 62 and 64 to move to another channel of channels 12 and 14 if, for example, no packets are received.

When scanning a channel of channels 12 and 14, packets are received, information is extracted and possibly analyzed, and a set of statistics or characteristics for that channel may be updated based on the information. Statistics may be updated, for example, as new packets are received. The collected packets may be analyzed to extract information which may indicate if the channel of channels 12 and 14 or AP of APs 40 and 42 is not suitable (e.g., has too much load or traffic, has poor quality, does not have the required characteristics, etc). Information extracted from packets may include, for example, to DS/from DS bits, the BSS identification (e.g., BSSID), or other identifier of an AP of APs 40 and 42, information indicating if the packet is from a BSS or Independent Basic Service (IBSS), and other information. Packets may be filtered to, for example, eliminate less useful packets. For example, packets where a DS or other informational bit indicates the packet is being sent from one AP of APs 40 and 42 to another AP may be filtered and eliminated. Other filtering may be performed.

Statistics for a channel of channels 12 and 14 may be kept on, for example, the percent of time the channel is busy, an indication of channel load; the percentage of packets which are retry packets (which in an exemplary embodiment may be extracted from a “retry” bit in packets; when a retry is detected a counter may be increased); the number of active stations of stations 60, 62 and 64 using the channel (e.g., when a packet with a different station ID is received, a counter may be increased); and the signal strength of the packets received (for example, in the form of the average RSSI of the packets, or in other forms), Such factors or characteristics may indicate that a channel of channels 12 and 14, an AP of APs 40 and 42, or a BSS or an IBSS is not suitable or desirable. Other characteristics or factors may be used.

In an exemplary embodiment, RSSI may be determined by, for example, sampling the signal strength during the frame or packet reception and averaging the measured value over a number of sampling points, for example, using a sliding window method. Other ways of calculating signal strength may be used.

Retry statistics may be measures of collisions, bad packets, interference, distance factors or other transmission problems, etc. Other methods may be used to measure these various events.

Other or additional characteristics may be used. Factors that may be used are, for example, the signal quality of the packets received (for example, in the form of the average quality, or in other forms); the data rate of the AP of APs 40 and 42 (which may be determined, for example, from identifiers within packets); the security type supported by the AP of APs 40 and 42 (which may be determined from the packets); and/or quality of service aspects of the AP of APs 40 and 42 (which also may be determined from the packets received), such as, for example whether voice or video over IP is supported.

Although the scope of the present invention is not limited in this respect, counters may be kept for a channel of channels 12 and 14. Counters may be kept for, for example, the number of packets received, the number of retries, the number of different stations of stations 60, 62 and 64 using the channel of channels 12 and 14, and other information. Other characteristics may be extracted and analyzed, and other methods of keeping or analyzing such data may be used, if desired.

More than one AP of APs 40 and 42 or BSS or IBSS may transmit information on one channel of channels 12 and 14 if, for example, there is overlap in service areas. In such a case, the station of stations 60, 62 and 64 may sort out which packets are from which AP of APs 40 and 42, or from which BSS or IBSS, and determine separately, for a set of APs, BSSs or BSSs, if either is desirable or not desirable. Further, if, for example, one AP of APs 40 and 42 or BSS or IBSS is determined to be more dominant on a channel of channels 12 and 14 in the location of the station of stations 60, 62 and 64, interference from the less dominant AP of APs 40 and 42 or BSS or IBSS may be factored in to the desirability of the dominant AP or BSS or IBSS. For example, packets received from a more distant AP of APs 40 and 42, while not relevant for the BSS of a nearer AP of APs 40 and 42, may nevertheless add to the load on the channel of channels 12 and 14 of the nearer AP.

In an exemplary embodiment, if the packets on a channel of channels 12 and 14 indicate that the channel is dominated by an IBSS, the station of stations 60, 62 and 64 may ignore the channel, decide not to continue scanning the channel, and move to a different channel. In other embodiments, an IBSS may be further evaluated for desirability.

In an exemplary embodiment, a decision is made to reject or not choose a channel of channels 12 and 14 and to switch to analyzing a different channel if certain channel statistics or characteristics meet, reach or pass certain thresholds. Such a decision may be made after a certain amount of information and number of packets is received, to ensure accuracy. In one embodiment, this may be, for example, 50 packets, but may be other numbers. The thresholds may be pre-set, but alternately may be set by users.

For example, if the channel load rises or is calculated to be past a certain percentage, in one embodiment 70% of the time busy (this may be expressed in other ways, such as, for example “clear channel” percentage); if the number of active stations of stations 60, 62 and 64 in a channel of channels 12 and 14 rises or is calculated to be over a certain threshold (e.g., in one embodiment, 16, but other thresholds may be used, as suitable); if the average quality of the packets AP of APs 40 and 42 goes below or is found to be lower than a certain threshold (e.g., if the average RSSI of an AP is below −80 dBm); or if the average percentage of packets that are retries rises or is calculated to be greater than a certain threshold (e.g., 50%), the station of stations 60, 62 and 64 switches analysis to a different channel. In an exemplary embodiment any of these factors reaching or breaking a threshold may individually trigger a decision to switch scanning to another channel. In other embodiments other methods may be used, such as, for example having a combination of factors trigger a move. Other specific thresholds may be used, and other characteristics or statistics, or other sets of characteristics or statistics, may be analyzed and acted on. The specific numbers given as thresholds are given by way of example only, and other specific numbers may be used as suitable. The station of stations 60, 62 and 64 performing the analysis may or may not be counted among the number of active stations in a channel of channels 12 and 14; whether or not to do so merely involves adjusting the threshold.

While certain thresholds are expressed, these thresholds are provided by way of example only, and other suitable limits may be used. In alternate embodiments, methods of deciding to switch channels using factors other than thresholds may be used. For example, whether certain characteristics match or are close to a desired set of characteristics may aid in a decision. Further, while in an exemplary embodiment, if any one of a set of characteristics or statistics passes or reaches a certain threshold a switch is made, in other embodiments a combination of characteristics may be used, rather than absolute thresholds. For example, the characteristics may be normalized and weighted, and the normalized and weighted characteristics combined to an overall measure of quality or desirability, which may be used to make a decision. Other decision methods may be used.

In other embodiments, thresholds or other target characteristics may be based on the needs of the station of stations 60, 62 and 64, and thus may be altered based on the needs or characteristics of the station. For example, the desired data transfer rate of the station, the applications that are likely to be used (e.g., multimedia vs. text email), or other needs may be considered.

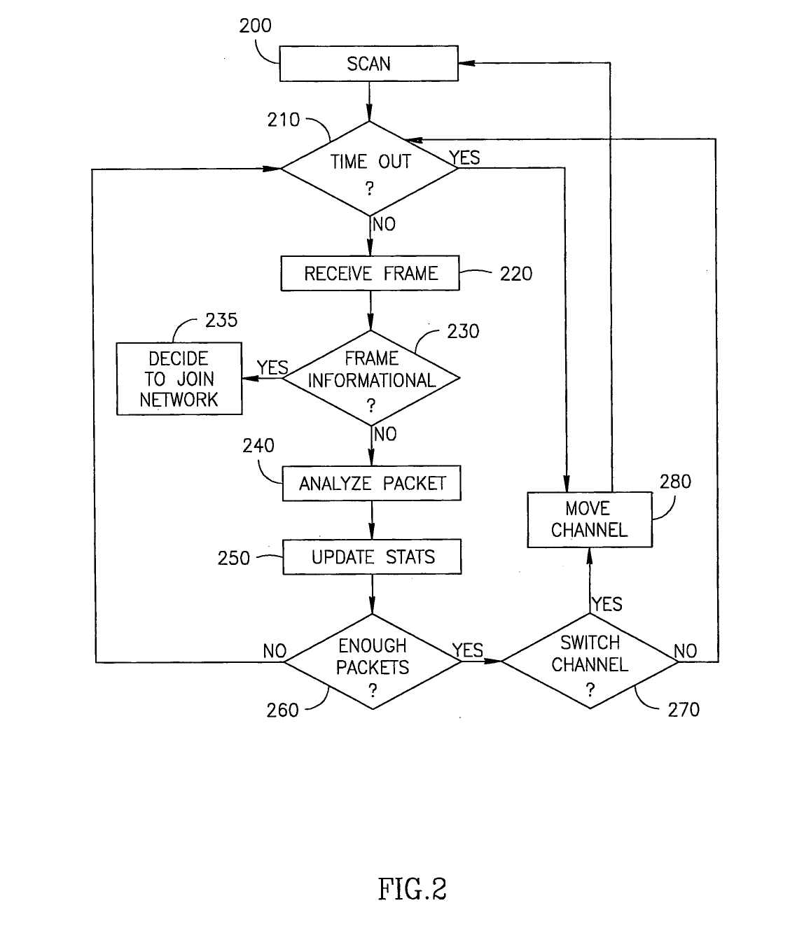

FIG. 2 is a flowchart depicting a series of operations according to an exemplary embodiment of the present invention.

In operation 200, a station starts scanning a channel. The station may receive and possibly record all traffic sent on the channel. The scanning may be passive.

In operation 210, if a timeout has occurred without receiving a packet, the station may move to operation 280.

In operation 220, an informational unit such as, for example a packet or frame is received for the channel. A counter may be incremented recording the number of packets received.

In operation 230, if the informational unit received in operation 220 is a beacon or other informational frame, the station may end the scanning process and may, in operation 235, analyze the beacon and may decide whether or not to try to join with an AP based on the beacon; however, in other embodiments, the station may continue scanning, or continue analyzing frames. If the informational unit received in operation 220 is not a beacon or other informational frame the method proceeds to operation 240.

In operation 240, the packet is analyzed. Specific information may be extracted, and further in some embodiments analysis may be performed on the information.

In operation 250, statistics for the channel being analyzed are updated based on the information extracted or analyzed in operation 240.

In operation 260, if not enough packets are collected the station moves to operation 210, and continues collecting packets. The number of packets collected for the relevant channel may be recorded (in some embodiments such information may be adjusted by, for example, packets that are irrelevant or filtered out). In alternate embodiments, for some statistics or characteristics, there may be no lower limit on the number of packets received for action to occur. If one of the conditions for leaving the channel is satisfied (for example, the number of stations in the channel is above a threshold, such as, for example 10), then the station may move to other channel even if number of received packets is below a pre-set threshold. If enough packets are collected the station moves to operation 270.

In operation 270 if any of the relevant characteristics or statistics, or the set of factors as a whole, indicates the channel should be switched, the station moves to operation 280; otherwise the station moves to operation 210 to continue receiving information on the current channel. For example, if any of the relevant characteristics or statistics are at or beyond a certain threshold, the channel may be switched.

In operation 280, the station moves to another channel, and proceeds to operation 200 to start scanning.

Other operations or series of operations may be used, and certain operations may be omitted.

If the station of stations 60, 62 and 64 moves through and eliminates all detectable channels of channels 12 and 14 or APs 40 and 42 (or all channels or AP in a certain set of channels or APs), the station of stations 60, 62 and 64 may, for example, select the best or most suitable (according to the criteria described above), according to the information collected during the scanning period. If the station of stations 60, 62 and 64 decides that no suitable channels of channels 12 and 14 or APs of APs 40 and 42 were found, the station of stations 60, 62 and 64 may wait and may repeat scanning periodically.

It will be appreciated by persons skilled in the art that the present invention is not limited by what has been particularly shown and described hereinabove. Rather the scope of the invention is defined by the claims that follow:

What is claimed is:

1. A method comprising:
receiving packets on a wireless network;
determining from the received packets information regarding a channel; and
if said information indicates the channel is not desirable, before an informational packet is received, switching to a different channel for scanning.

2. The method of claim 1, comprising, if a factor passes a threshold, determining the channel is not desirable.

3. The method of claim 1, comprising determining if the number of retries for the channel is above a threshold.

4. The method of claim 1, comprising determining if the percent of time the channel is busy is above a threshold.

5. The method of claim 1, comprising determining if the number of active stations using the channel is above a threshold.

6. The method of claim 1, comprising determining if the strength of a signal on the channel is below a threshold.

7. The method of claim 1 comprising, if an informational packet is received, transmitting a request to join.

8. A wireless communication device comprising:
a controller to passively scan a channel on a wireless network to receive packets;
the controller to determine from the received packets information regarding the channel; and
wherein said controller is, if said information indicates the channel is not desirable, to switch to a different channel for scanning before an informational packet is received.

9. The device of claim 8, wherein the informational packet is a beacon packet or probe response.

10. The device of claim 8, wherein the channel is a communications channel with an access point, the access point providing a connection to a network.

11. The device of claim 8, wherein the controller is to, if a factor passes a threshold, determine the channel is not desirable.

12. The device of claim 8, wherein the controller is to determine if the number of retries for the channel is above a threshold.

13. The device of claim 8, wherein the controller is to determine if the percent of time the channel is busy is above a threshold.

14. The device of claim 8, wherein the controller is to determine if the number of active stations using the channel is above a threshold.

15. The device of claim 8, wherein the controller is to determine if the strength of a signal on the channel is below a threshold.

16. The device of claim 8, wherein the controller is to, if an informational packet is received, transmit a request to join.

17. A wireless communication device comprising:
a dipole antenna;
a controller to passively scan a channel on a wireless network to receive packets;
the controller to determine from the received packets information regarding the channel; and
wherein said controller is, if said information indicates the channel is not desirable, to switch to a different channel for scanning before an informational packet is received.

18. The system of claim 17, wherein the controller is to, if a factor passes a threshold, determine the channel is not desirable.

19. The system of claim 17, wherein the informational packet is a beacon packet or probe response.

20. A wireless communication system comprising:
an access point; and
a communications device including at least:
a controller to passively scan a channel corresponding to the access point to receive packets;
the controller to determine from the received packets information regarding the channel; and
wherein said controller is, if said information indicates the channel is not desirable, to switch to a different channel for scanning before an informational packet is received.

21. The system of claim 20, wherein the informational packet is a beacon packet or probe response.

22. The system of claim 20, wherein the controller is to, if a factor passes a threshold, determine the channel is not desirable.

23. An article comprising a storage medium having stored therein instructions that when executed by a computing platform result in at least:
packets being received from a wireless network;
determining from the received packets information regarding a channel; and
if said information indicates the channel is not desirable, before an informational packet is received, switching to a different channel for scanning.

24. The article of claim 23, wherein the instructions when executed by a computing platform result in at least, if a factor passes a threshold, determining the channel is not desirable.

25. The article of claim 23, wherein the instructions when executed by a computing platform result in at least determining if the number of retries for the channel is above a threshold.

26. A method comprising if, before an informational packet it received, it is determined from a set of received packets on a channel that the channel is not desirable, switching to a different channel for scanning.

27. The method of claim 26, comprising, if a factor passes a threshold, determining the channel is not desirable.

28. The method of claim 26 comprising, if an informational packet is received, transmitting a request to join.
